(19) United States
(12) Patent Application Publication
(10) Pub. No.: US 2021/0286282 A1
(43) Pub. Date: Sep. 16, 2021

(54) WHITE TONER

(71) Applicant: CANON KABUSHIKI KAISHA, Tokyo (JP)

(72) Inventors: Takakuni Kobori, lbaraki (JP); Kenta Mitsuiki, lbaraki (JP); Hitoshi Sano, Chiba (JP); Wakiko Katsumata, Chiba (JP); Daisuke Yamashita, Chiba (JP); Yosuke Iwasaki, Tokyo (JP); Takeshi Ohtsu, lbaraki (JP); Takaho Shibata, Tokyo (JP); Masaharu Miura, lbaraki (JP); Koh lshigami, Chiba (JP); Yuichi Mizo, lbaraki (JP)

(21) Appl. No.: 17/334,192

(22) Filed: May 28, 2021

Related U.S. Application Data
(63) Continuation of application No. PCT/JP2019/046423, filed on Nov. 27, 2019.

(30) Foreign Application Priority Data
Dec. 3, 2018 (JP) 2018-226712

(51) Int. Cl. G03G 9/09; G03G 9/097

(52) U.S. Cl. CPC G03G 9/0902; G03G 9/09725

(57) ABSTRACT

The present invention provides a white toner which has high charge uniformity and enables stable print-out of high-quality images irrespective of its usage environment. The above object can be solved by a white toner including a white toner particle containing a binder resin, a white pigment and an inorganic fine particle, in which the white pigment has a work function of 5.80 eV or more and 6.10 eV or less, the content of the white pigment is 15.0 parts by mass or more and 60.0 parts by mass or less relative to 100 parts by mass of the binder resin, and the inorganic fine particle has a work function of 6.15 eV or more.

### CROSS-REFERENCE TO RELATED APPLICATIONS

This application is a Continuation of International Patent Application No. PCT/JP2019/046423, filed Nov. 27, 2019, which claims the benefit of Japanese Patent Application No. 2018-226712 filed Dec. 3, 2018, both of which are hereby incorporated by reference herein in their entirety.

### BACKGROUND OF THE INVENTION

### Field of the Invention

The present invention relates to a toner used in electrophotographic methods, electrostatic recording methods, electrostatic printing methods, and toner jet methods.

### Description of the Related Art

As an image forming apparatus using electrophotography, an image forming apparatus which forms toner images on a transfer material using not only color toners such as yellow, magenta, cyan, and black toners but also a white toner having a color of white is suggested in the related art. For example, by color printing on color paper sheets rather than white paper sheets or printing of a white toner as an undercoat, hues of images formed with color toners are made vivid, thereby enabling a variety of expressions.

A variety of white pigments used as the white toner are suggested. For example, Japanese Patent Publication No. H07-082243 suggests use of one selected from the group consisting of aluminum oxide, titanium oxide, magnesium oxide, and calcium oxide, as the white pigment. However, the white pigment is likely to be positively charged, and causes uneven charge of the toner when used as a negative toner. This will result in a broad charge amount distribution. Such a broad charge amount distribution may cause a fogging phenomenon in non-image portions, resulting in no followability of the charge amount in response to a change in its usage environment and no image density stability immediately after the power supply is turned on.

Moreover, Japanese Patent Application Laid-Open No. 2012-128008 suggests use of two types of titanium oxide particles in order to improve the whiteness and the lightfastness. However, even in this method, the charging stability in the usage environment is insufficient. Thus, the image density varies or the fogging phenomenon occurs with a change in usage environment.

An object of the present invention is to provide a white toner which can solve the above problems. Specifically, the object thereof is to provide a white toner which has high charge uniformity and can provide stable print-out of high-quality images irrespective of its usage environment.

### SUMMARY OF THE INVENTION

The present invention relates to a white toner including a white toner particle containing a binder resin, a white pigment and an inorganic fine particle, wherein the white pigment has a work function of 5.80 eV or more and 6.10 eV or less, the content of the white pigment is 15.0 parts by mass or more and 60.0 parts by mass or less relative to 100 parts by mass of the binder resin, and the inorganic fine particle has a work function of 6.15 eV or more.

Further features of the present invention will become apparent from the following description of exemplary embodiments with reference to the attached drawings.

### BRIEF DESCRIPTION OF THE DRAWINGS

FIG. 1 is a schematic view of a surface modification apparatus usable in the present invention.

FIG. 2 is a schematic view of a cell for measuring powder.

FIG. 3 is a schematic illustration of a surface analysis method.

### DESCRIPTION OF THE EMBODIMENTS

An embodiment for implementing the present invention will now be specifically described.

The present inventors have found that in the presence of a white pigment having a predetermined work function and an inorganic fine particle having a predetermined work function in a toner particle at the same time, the positive charging properties of the white pigment can be neutralized to enhance the charge uniformity of the entire toner.

In the white toner according to the present invention, a toner particle containing a binder resin contain 15.0 parts by mass or more and 60.0 parts by mass or less of a white pigment relative to 100 parts by mass of the binder resin, the white pigment having a work function of 5.80 eV or more and 6.10 eV or less.

If the content of the white pigment in the toner particle is within this range, a sufficient coloring ability can be obtained and the charge of the toner can be more uniformly controlled.

The white toner according to the present invention contains an inorganic fine particle having a work function of 6.15 eV or more.

The inorganic fine particle having such a work function and the white pigment having a work function of 5.80 eV or more and 6.10 eV or less, if contained in the toner particle at the same time, can neutralize charges of a positive polarity to stabilize the charges. As a result, occurrence of image defects can be suppressed even in a long-term use. The inorganic fine particle is contained in the toner particle in an amount of preferably 0.1 parts by mass or more and 15.0 parts by mass or less, more preferably 0.5 parts by mass or more and 10.0 parts by mass or less relative to 100 parts by mass of the binder resin. In particular, a content of 4.0 parts by mass or more and 9.0 parts by mass or less is preferred.

The inorganic fine particle preferably includes both of particles dispersed in inner portions of the white toner particle (where the inner portion of the white toner particle corresponds to a central region more than 0.50 μm deeper from the particle surface) and the particle present on the surfaces of the white toner particle. The amount of the inorganic fine particle present in the inner portions of the white toner particle is preferably 0.1 parts by mass or more and 2.5 parts by mass or less relative to 100 parts by mass of the binder resin. The amount of the inorganic fine particle present on the surfaces of the white toner particle is preferably 2.5 parts by mass or more and 7.0 parts by mass or less relative to 100 parts by mass of the inorganic fine particle before treatment. The presence of the inorganic fine particle on the surfaces of the white toner particle can relax influences caused by the temperature and the humidity accompanied by a variation in usage environment, resulting in higher charge uniformity.

In the present invention, the white pigment is preferably a white pigment selected from the group consisting of a titanium oxide fine particle, a calcium carbonate fine particle, a zinc oxide fine particle, an aluminum oxide fine particle, an aluminum hydroxide fine particle, and a magnesium oxide fine particle. These white pigments have a high coloring ability and are suitable for use in a negatively chargeable toner in viewpoint of charging properties.

The inorganic fine particle is preferably a silica fine particle. The silica fine particle can provide enhanced dispersibility of the white pigment in the toner particle without impeding the whiteness.

Next, the components contained in the white toner according to the present invention will be described.

[Binder Resin]

Any binder resin can be used without limitation, and the polymers or resins listed below can be used.

For example, the followings can be used: homopolymers of styrene and its substitutes such as polystyrene, poly-p-chlorostyrene, and polyvinyltoluene; styrene-based copolymers such as styrene-p-chlorostyrene copolymers, styrene-vinyltoluene copolymers, styrene-vinylnaphthalene copolymers, styrene-acrylate ester copolymers, styrene-methacrylic acid ester copolymers, styrene-α-chloromethyl methacrylate copolymers, styrene-acrylonitrile copolymers, styrene-vinyl methyl ether copolymers, styrene-vinyl ethyl ether copolymers, styrene-vinyl methyl ketone copolymers, and styrene-acrylonitrile-indene copolymers; poly(vinyl chloride), phenolic resins, natural modified phenolic resins, natural resin-modified maleic resins, acrylic resin, methacrylic resin, poly(vinyl acetate), silicone resins, polyesters, polyurethanes, polyamides, fran resins, epoxy resins, xylene resins, poly(vinyl butyral), terpene resins, coumarone-indene resins, and petroleum-based resins.

Among these resins, preferred is use of polyester or a hybrid resin of polyester and a vinyl-based resin from the viewpoint of low-temperature fixing properties and control of the charging properties.

Examples of the acid component and the alcohol component to prepare the polyester include a di- or higher hydric alcohol and a di- or higher valent carboxylic acid, and a di- or higher valent carboxylic anhydride and a di- or higher valent carboxylic acid ester.

Examples of the di- or higher hydric alcohol include alkylene oxide adducts of bisphenol A, such as polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane, and polyoxypropylene (6)-2,2-bis(4-hydroxyphenyl)propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbit, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Among these, the alcohol preferably used is aromatic diol. The proportion of the aromatic diol is preferably 80 mol % or more in the total alcohol monomer components which form the polyester.

On the other hand, examples of the acid monomer components such as the di- or higher valent carboxylic acid, the di- or higher valent carboxylic anhydride, and the di- or higher valent carboxylic acid ester include aromatic dicarboxylic acids, such as phthalic acid, isophthalic acid, and terephthalic acid, or anhydrides thereof alkyldicarboxylic acids, such as succinic acid, adipic acid, sebacic acid, and azelaic acid, or anhydrides thereof; succinic acid substituted by an alkyl or alkenyl group having 6 to 18 carbon atoms or anhydrides thereof; and unsaturated dicarboxylic acids such as fumaric acid, maleic acid, and citraconic acid or anhydrides thereof.

Among these, the acid monomer components preferably used are polyvalent carboxylic acids, such as terephthalic acid, succinic acid, adipic acid, fumaric acid, trimellitic acid, pyromellitic acid, and benzophenone tetracarboxylic acid, and anhydrides thereof.

The polyester preferably has an acid value of 1 mgKOH/g or more and 20 mgKOH/g or less from the viewpoint of the stability of the frictional charge amount. The acid value can be controlled within this range by adjusting the type of the monomer used in the resin or the amount thereof blended. Specifically, the acid value can be controlled by adjusting the proportion of the alcohol and the acid or the molecular weight during the preparation of the resin. Alternatively, the acid value can be controlled by performing ester polycondensation, followed by a reaction of a terminal alcohol with a polyvalent acid monomer (such as trimellitic acid).

In the case of a hybrid resin of a polyester and a vinyl-based resin, a bireactive monomer reactive with these resin components may be used.

[Wax]

The white toner particle may contain wax. Any wax can be used without limitation. Examples of the wax include the followings: hydrocarbon-based waxes such as low molecular weight polyethylenes, low molecular weight polypropylenes, alkylene copolymers, microcrystalline waxes, paraffin waxes, and Fischer-Tropsch waxes; oxides of hydrocarbon-based waxes, such as oxidized polyethylene waxes, or block copolymers thereof; waxes containing fatty acid esters as the main component, such as carnauba wax; and those obtained by partially or completely deoxidizing fatty acid esters, such as deacidified carnauba wax. Additional examples of the wax include the followings: saturated linear fatty acids such as palmitic acid, stearic acid, and montanic acid; unsaturated fatty acids such as brassidic acid, eleostearic acid, and parinaric acid; saturated alcohols such as stearyl alcohol, aralkyl alcohol, behenyl alcohol, carnaubyl alcohol, ceryl alcohol, and melissyl alcohol; polyhydric alcohols such as sorbitol; esters of a fatty acid such as palmitic acid, stearic acid, behenic acid, or montanic acid with an alcohol such as stearyl alcohol, aralkyl alcohol, behenyl alcohol, carnaubyl alcohol, ceryl alcohol, or melissyl alcohol; fatty acid amides such as linoleic acid amide, oleamide, and lauric acid amide; saturated fatty acid bisamides such as methylene bisstearamide, ethylene biscapric acid amide, ethylene bislauric acid amide, and hexamethylene bisstearamide; unsaturated fatty acid amides such as ethylenebisoleamide, hexamethylenebisoleamide, N,N′-dioleyladipic acid amide, and N,N′-dioleylsebacic acid amide; aromatic bisamides such as m-xylenebisstearamide and N,N′-distearylisophthalic acid amide; aliphatic metal salts (those generally referred to as metal soaps) such as calcium stearate, calcium laurate, zinc stearate, and magnesium stearate; waxes obtained by grafting aliphatic hydrocarbon-based waxes with a vinyl-based monomer such as styrene or acrylic acid; partially esterified products of a fatty acid such as monoglyceride behenate with a polyhydric alcohol; and methyl ester compounds having a hydroxyl group obtained by hydrogenation of vegetable oils and fats.

Among these waxes, preferred are hydrocarbon-based waxes such as paraffin wax and Fischer-Tropsch wax to improve the low-temperature fixing properties and resistance against winding at fixing.

The content of the wax to be used is preferably 0.5 to 20 parts by mass relative to 100 parts by mass of the binder resin. From the viewpoint of compatibility between the storage properties of the toner and high temperature off-setting properties, preferred is a wax having the largest endothermic peak at a peak temperature of 50 to 110° C. in an endothermic curve obtained as a result of measurement with a differential scanning calorimeter (DSC).

[Charge Control Agent]

The white toner particle may contain a charge control agent as needed. A known charge control agent can be used. In particular, preferred is a metal compound of an aromatic carboxylic acid, which is colorless, charges the toner fast, and can stably retain a fixed charge amount.

Example of a negative charge control agent include salicylic acid metal compounds, naphthoic acid metal compounds, dicarboxylic acid metal compounds, polymer compounds having sulfonic acid or carboxylic acid in the side chains, polymer compounds having sulfonate or an esterified product of sulfonic acid in the side chains, polymer compounds having carboxylic acid or an esterified product of carboxylic acid in the side chains, boron compounds, urea compounds, silicon compounds, and calixarene. The charge control agent may be internally added to or externally added to the toner particle. The content of the charge control agent is preferably 0.2 to 10 parts by mass relative to 100 parts by mass of the binder resin.

[External Additive]

The white toner according to the present invention may further contain an external additive as needed to enhance the fluidity or adjust the frictional charge amount.

Preferred external additives are an inorganic fine particle such as a silica fine particle, a titanium oxide fine particle, an aluminum oxide fine particle, and a strontium titanate fine particle. Moreover, the inorganic fine particle is preferably hydrophobized with a hydrophobizing agent such as a silane compound, silicone oil, or a mixture thereof.

The external additive is preferably used in an amount of 0.1 to 5.0 parts by mass relative to 100 parts by mass of the toner particle.

[Carrier]

The white toner according to the present invention is preferably mixed with a magnetic carrier and used as a two-component developer because stable images are obtained for a long time.

Generally known magnetic carriers can be used, and examples thereof include surface-oxidized iron powder, unoxidized iron powder, particles of metals such as iron, lithium, calcium, magnesium, nickel, copper, zinc, cobalt, manganese, and rare earth elements, particles of alloys thereof, oxide particles, magnetic substances such as ferrite, and magnetic substance-dispersed resin carriers (so-called resin carriers) containing a magnetic substance and a binder resin which can hold the magnetic substance so as to be dispersed.

[Production Method]

The white toner according to the present invention can be produced by a traditionally known production method such as emulsion agglomeration, melt kneading, or dissolution suspension method. Preferred is knead grinding from the viewpoint of the dispersibility of raw materials.

In knead grinding, initially, raw materials are mixed. In the raw material mixing step, predetermined amounts of materials which constitute the white toner particle are weighed, blended and mixed, the materials including a binder resin, a white pigment, an inorganic fine particle, and other optional components such as a charge control agent, wax, and a colorant. Examples of mixing apparatuses include a double-cone mixer, a V-type mixer, a drum-type mixer, a supermixer, a Henschel mixer, a Nauta mixer, and a mechanohybrid (manufactured by NIPPON COKE & ENGINEERING CO., LTD.).

Preferably, the amount of the inorganic fine particle to be mixed here corresponds to only the amount of the inorganic fine particle present in the inner portions of the white toner particle (where the inner portion of the white toner particle corresponds to a central region more than 0.50 μm deeper from the particle surface). Specifically, the inorganic fine particle is preferably used in an amount of 0.1 parts by mass or more and 2.5 parts by mass or less relative to 100 parts by mass of the binder resin.

Next, the mixed materials are melt kneaded to disperse the raw materials other than the binder resin in the binder resin. In the melt kneading step, a batch-type kneader such as a pressure kneader or a Banbury mixer or a continuous kneader can be used. A single- or double-screw extruder is mainly used because of its advantage in that continuous production is enabled. Examples of the extruder include a KTK-type double-screw extruder (manufactured by Kobe Steel, Ltd.), a TEM-type double-screw extruder (manufactured by TOSHIBA MACHINE CO., LTD.), a PCM kneader (manufactured by Ikegai Corp.), a double-screw extruder (manufactured by KCK K.K.), a co-kneader (manufactured by Buss-SMS-Canzler GmbH), and Kneadex (manufactured by NIPPON COKE & ENGINEERING CO., LTD.). Furthermore, a resin composition obtained through melt kneading may be rolled with a double roll or the like, and may be cooled with water or the like in the cooling step.

In the next step, the cooled product of the resin composition is ground into a desired particle diameter in the grinding step. In the grinding step, the cooled product is roughly ground with a mill such as a crusher, a hammer mill, or a feather mill, for example, and is then further pulverized with a CRYPTRON system (manufactured by Kawasaki Heavy Industries, Ltd.), a Super Rotor (manufactured by NIS SHIN ENGINEERING INC.), a turbo mill (manufactured by FREUND-TURBO CORPORATION), or an air jet pulverizer, for example.

Subsequently, the pulverized product is classified with a classifier such as an inertial classification type Elbow-Jet (manufactured by Nittetsu Mining Co., Ltd.), a centrifugal classification type Turboplex (manufactured by Hosokawa Micron Corporation), a TSP separator (manufactured by Hosokawa Micron Corporation), or a FACULTY (manufactured by Hosokawa Micron Corporation) or a sieve as needed to yield a toner particle.

After the grinding, the toner particle can be optionally subjected to a surface treatment such as spheronization using a hybridization system (manufactured by Nara Machinery Co., Ltd.), a MECHANO FUSION system (manufactured by Hosokawa Micron Corporation), a FACULTY (manufactured by Hosokawa Micron Corporation), or a Meteorainbow MR Type (manufactured by Nippon Pneumatic Mfg. Co., Ltd.).

In particular, in the present invention, preferably, additives such as an inorganic fine particle and a resin particle are added to the surface of the white toner particle, and are dispersed with mixing; in this dispersed state, the white toner particle is subjected to a surface treatment with hot air to fix the additives onto the surface of the white toner particle. Preferably, the amount of the inorganic fine particle to be mixed corresponds to only the amount of the inorganic fine particle present on the surface of the white toner particle. Specifically, the inorganic fine particle is preferably used in an amount of 2.5 parts by mass or more and 7.0 parts by mass or less relative to 100 parts by mass of the toner particle before the treatment.

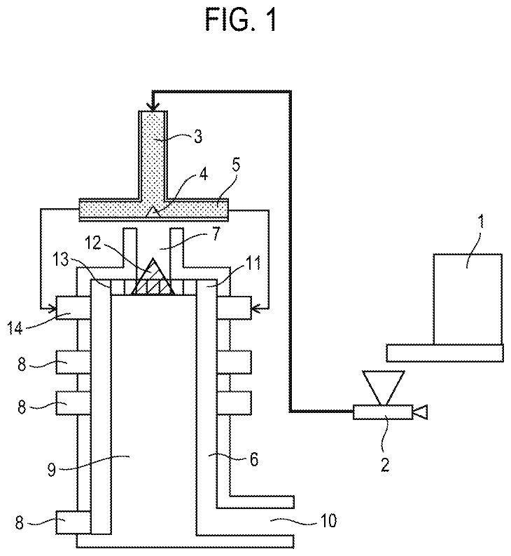

In the present invention, the white toner particle can be subjected to a surface treatment with hot air using the surface treatment apparatus illustrated in FIG. 1, for example, and can be optionally classified to yield a white toner. Hereinafter, the surface treatment will be described with reference to FIG. 1.

A mixture quantitated and fed by a raw material quantitating feeding unit 1 is guided to an introduction pipe 3, which is disposed vertically to the raw material feeding unit, by a compressed gas adjusted by a compressed gas adjusting unit 2. The mixture passing through the introduction pipe is homogeneously dispersed by a conically protruded member 4 disposed in a central portion of the raw material feeding unit, is guided to feeding pipes 5 radially disposed in eight directions, and then is guided to a treatment chamber 6 where the mixture is subjected to a heat treatment.

At this time, a flow of the mixture fed to the treatment chamber is restricted by a restricting unit 9 for restricting the flow of the mixture, the restricting unit being disposed within the treatment chamber. For this reason, the mixture fed to the treatment chamber undergoes a heat treatment while swirling within the treatment chamber, followed by cooling.

The hot air used for heat treatment of the fed mixture is fed from a hot air feeding unit 7, and is distributed by a distribution member 12. The hot air is spirally swirled within the treatment chamber by a swirling member 13 for swirling the hot air, and is introduced from an outlet 11 of the hot air feeding unit. The swirling member 13 is configured to have a plurality of blades to control the swirling of the hot air according to the number of blades and the angle thereof. For the hot air fed into the treatment chamber, the temperature thereof in the outlet of the hot air feeding unit 7 is preferably 100 to 300° C., more preferably 130 to 170° C. If the temperature of the hot air in the outlet of the hot air feeding unit is within this range, fusion or adhesion of the toner particle caused by excessive heating of the mixture can be prevented, and the toner particle can be uniformly subjected to a spheronization treatment. The average circularity at this time is preferably 0.955 to 0.980.

Furthermore, the heat-treated white toner particle is cooled with the cooling air fed from a cooling air feeding unit 8. The temperature of the cooling air fed from the cooling air feeding unit 8 is preferably −20 to 30° C. If the temperature of the cooling air is within the range, the heat-treated toner particle can be efficiently cooled, and the fusion or adhesion of the heat-treated toner particle can be prevented without impeding the uniform spheronization treatment of the mixture. The absolute moisture content in the cooling air is preferably 0.5 to 15.0 g/m³.

Next, the cooled heat-treated white toner particle is recovered by a recovering unit 10 disposed at a lower end of the treatment chamber. To be noted, a blower (not illustrated) is disposed upstream of the recovering unit, and is configured to suction and transport the white toner particle.

A powdery particle feeding port 14 is disposed such that the swirling direction of the fed mixture and that of the hot air are directed in the same direction. The recovering unit 10 in the surface treatment apparatus is disposed in an outer circumferential portion of the treatment chamber to maintain the swirling direction of the swirled powdery particle. Furthermore, the apparatus is configured such that the cooling air fed from the cooling air feeding unit 8 is fed in the tangent direction from the outer circumferential portion of the apparatus to the inner circumferential surface of the treatment chamber. The swirling direction of the white toner particle before the heat treatment fed from the powder feeding port, that of the cooling air fed from the cooling air feeding unit, and that of the hot air fed from the hot air feeding unit are all directed in the same direction. For this reason, the swirling stream inside the apparatus is reinforced without causing any turbulence within the treatment chamber, and a strong centrifugal force is applied to the white toner particle before the heat treatment to further enhance the dispersibility of the white toner particle before the heat treatment, thus resulting in heat-treated toner particle having a uniform shape with a small amount of adhering particles.

In the next step, the resulting toner particle is subjected to an external addition treatment as needed.

Examples of mixing apparatuses used in the external addition treatment include a double-cone mixer, a V-type mixer, a drum-type mixer, a supermixer, a Henschel mixer, a Nauta mixer, and a mechanohybrid (manufactured by NIPPON COKE & ENGINEERING CO., LTD.).

Next, the methods for measuring the physical properties related to the present invention will be described.

<Method of Measuring Work Functions of White Pigment and Inorganic Fine Particle>

The work function was measured using a surface analyzer (AC-2, low energy electron counting method, manufactured by RIKEN KEIKI Co., Ltd.). In the present invention, a deuterium lamp was used in the apparatus, and the setting value of the light irradiation quantity was 500 nW. Monochromatic light was selected with a spectroscope. The spot had a size of 4 mm square. The range of energy scan was set at 4.20 to 6.20 eV, and the interval was set to 0.05 eV. A sample was irradiated at 10 sec/point as the measurement time to detect photoelectrons released from the sample surface. The work function is measured at a repetitive accuracy (standard deviation) of 0.02 eV. A cell for measurement of powder was used to measure powder.

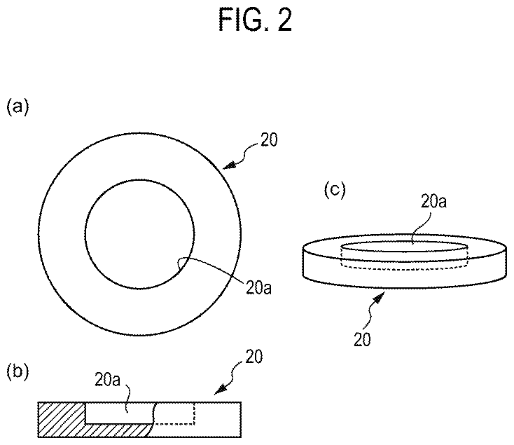

FIG. 2 is a schematic view of a cell for measurement of powder. (a) is a plan view of a cell 20, (b) is a partially cut-out side view thereof, and (c) is a perspective view thereof. The cell 20 has a recess 20a for accommodating a sample in the center of a stainless steel disk having a diameter of 30 mm and a height of 5 mm, the recess having a diameter of 15 mm and a depth of 3 mm. A sample is placed into the recess 20a using a measuring spoon without pressing down the sample, and the surface of the sample is then leveled using the edge of a knife. In this state, the cell for measurement is fixed onto a predetermined position of the sample stand to perform measurement.

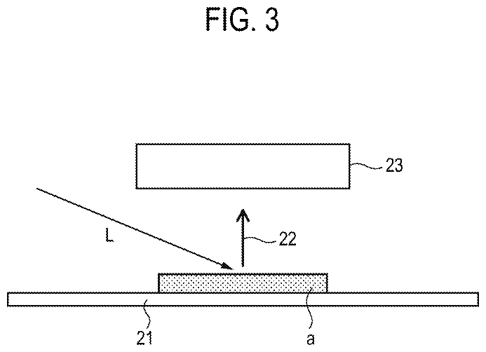

As shown in FIG. 3, the cell (a) for measurement is fixed onto the predetermined position of the sample stand 21 such that the irradiated surface of the sample is even to the irradiation direction of the light L for measurement. Thus, photoelectrons 22 to be released are more efficiently detected by a detector (photomultiplier tube) 23. In this surface analysis, release of photons starts from a certain energy value (eV) by scanning the excitation energy of the monochromatic light from lower to higher energy. The energy value is referred to as work function (eV). To ensure data reproductivity, the sample for measurement was a product left to stand under a condition at a temperature of 23° C. and a humidity of 60 RH % for 24 hours.

<Method of Measuring Content of White Pigment and that of Inorganic Fine Particle in White Toner Particle>

2 (ml) of a non-ionic surfactant (preferably CONTAMINON N (manufactured by Wako Pure Chemical Industries, Ltd.: trade name)) is added to 200 (ml) of deionized water, and is dispersed for 10 hours with an ultrasonic dispersing machine to float the total amount of the external additives added to the white toner. The content of the white colorant present in the white toner particle or that of the inorganic fine particle is calculated from fluorescent X-ray measurement.

The fluorescent X-ray measurement of the elements is performed according to JIS K 0119-1969, and is specifically as follows.

A wavelength dispersive X-ray fluorescence analyzer “Axios” (manufactured by PANalytical Ltd.) is used as a measurement apparatus, and dedicated software “SuperQ ver. 4.0F” (manufactured by PANalytical Ltd.) attached thereto for setting the measurement conditions and analyzing the data obtained from the measurement is used. To be noted, Rh is used as the anode of the X-ray tube, the atmosphere for measurement is in vacuum, the diameter for measurement (diameter of the collimator mask) is 27 mm, and the measurement time is 10 seconds. Detection is performed with a proportional counter (PC) in the measurement of a light element and with a scintillation counter (SC) in the measurement of a heavy element.

Pellets prepared as follows are used as the sample for measurement: About 4 g of a toner is placed into a dedicated aluminum ring for press, and is leveled. The toner is pressurized using a tablet molding press machine “BRE-32” (manufactured by Maekawa Testing Machine Mfg. Co., LTD.) at 20 MPa for 60 seconds to be molded into pellets having a thickness of about 2 mm and a diameter of about 39 mm.

The measurement is performed under the above conditions, and the element is identified based on the obtained X-ray peak position. From the counting rate (unit: cps), which is the number of X-ray photons per unit time, the concentration is calculated.

In the case of the white pigment, the white pigment is added in an amount of 10.0 parts by mass relative to 100 parts by mass of the binder resin, followed by sufficient mixing using a coffee mill. The resulting mixture is used as a sample for a calibration curve. Similarly, the white pigment is mixed in each of the amounts of 30.0 parts by mass, 50.0 parts by mass, and 70.0 parts by mass with the binder resin. These mixtures are used as samples for a calibration curve.

In the case of the inorganic fine particle, the inorganic fine particle is mixed in each of the amounts of 0.1 part by mass, 1.0 part by mass, and 2.5 parts by mass relative to 100 parts by mass of the binder resin. These mixtures are used as samples for a calibration curve.

These samples are prepared into pellets of the samples for the calibration curve using a tablet molding press machine, as described above, to measure the counting rate (unit: cps) of the Si—Kα ray observed at a diffraction angle (20) of 109.08° where PET is used as an analyzing crystal. At this time, the accelerating voltage and the current value of the X-ray generator are 24 kV and 100 mA, respectively. The resulting counting rate of the X-ray is plotted as the ordinate and the amount of white colorant or inorganic fine particle added in each sample for the calibration curve is plotted as the abscissa to create a calibration curve derived from a primary function.

Next, the toner to be analyzed is formed into pellets using a tablet molding press machine as described above to measure the counting rate of the Si-Kα ray thereof. From the calibration curve above, the content of the white colorant or inorganic fine particle in the toner is calculated.

<Method of Measuring Softening Point (Tm) of Binder Resin>

Using a constant load extrusion-type capillary rheometer “Rheological Properties Evaluator Flowtester CFT-500D” (manufactured by SHIMADZU Corporation), the softening point of the resin is measured according to a manual attached to the evaluator. In the evaluator, while a constant load is being applied to a sample for measurement by a piston from above the sample, the sample for measurement charged into a cylinder is melted by heating. The melted sample for measurement is extruded from the die of the cylinder bottom. Thus, a flow curve representing the relation between the amount of the piston stroke and the temperature at this time can be obtained.

In the present invention, the “melting temperature according to a ½ method” described in the manual attached to the “Rheological Properties Evaluator Flowtester CFT-500D” is defined as the softening point. The melting temperature according to the ½ method is calculated as follows. Initially, ½ of the difference between the amount Smax of piston stroke at the end of outflow and the amount Smin of piston stroke at the start of outflow is determined (this is defined as X. X=(Smax−Smin)/2). The temperature in the flow curve when the amount of piston stroke reaches X in the flow curve corresponds to the melting temperature according to the ½ method.

The sample for measurement to be used is prepared by compression molding about 1.0 g of a resin into a cylindrical shape having a diameter of about 8 mm under a 25° C. environment at about 10 MPa for about 60 seconds using a tablet molding press machine (for example, NT-100H, manufactured by NPa SYSTEM CO., LTD.).

CFT-500D is set to the following measurement conditions.

test mode: temperature raising method

starting temperature: 50° C.

temperature to reach: 200° C.

interval for measurement: 1.0° C.

heating rate: 4.0° C./min

cross-sectional area of the piston: 1.000 cm²

test load (piston load): 10.0 kgf (0.9807 MPa)

preheating time: 300 seconds

diameter of pore of die: 1.0 mm

length of die: 1.0 mm

<Measurement of Weight Average Molecular Weight of Binder Resin>

The molecular weight distribution of THF-soluble contents in the binder resin is measured by gel permeation chromatography (GPC) as follows.

A column is stabilized in a 40° C. heat chamber, and tetrahydrofuran (THF) as a solvent is flowed into the column at this temperature at a flow rate of 1 ml/min. About 100 μl of a THF sample solution is injected to perform measurement. In the measurement of the molecular weight of the sample, the molecular weight distribution that the sample has is calculated from the relation between the count value and the logarithmic value in a calibration curve created from several monodisperse polystyrene standard samples. As the standard polystyrene samples for creating the calibration curve, for example, those manufactured by Tosoh Corporation or Showa Denko K.K. having a molecular weight of about 10² to 10⁷ are used. Appropriately, at least 10 standard polystyrene samples or so are used. A refractive index (RI) detector is used as a detector. As the column, it is preferred that several commercially available polystyrene gel columns be combined. Examples thereof include the following combinations: a combination of Shodex GPC KF-801, 802, 803, 804, 805, 806, 807, and 800P manufactured by Showa Denko K.K., and a combination of TSKgel G1000H (H_{XL}), G2000H (H_{XL}), G3000H (H_{XL}), G4000H (H_{XL}), G5000H (H_{XL}), G6000H (H_{XL}), G7000H (H_{XL}), and TSKgurd columns manufactured by Tosoh Corporation.

The sample is prepared as follows.

50 mg of the sample is placed into 10 ml of THF, and is left to stand at 25° C. for several hours. The sample is then sufficiently shaken to mix the sample with THF well (until coalescences in the sample disappear), and is further left to stand for 12 hours or more. It is controlled such that the sample is left to stand in THF for 24 hours in total. Subsequently, the product which passes through a sample treatment filter (pore size: 0.2 or more and 0.5 μm or less, for example, MAISHORI DISK H-25-2 (manufactured by Tosoh Corporation) can be used) is used as a GPC sample.

<Measurement of Melting Point of Wax>

The melting point of wax is defined as the peak temperature of the largest endothermic peak in a DSC curve obtained in the measurement using a differential scanning calorimeter “Q2000” (manufactured by TA Instruments) according to ASTM D3418-82.

The temperature of the detector of apparatus is corrected using the melting point of zinc and that of indium while the heat quantity is corrected using the heat of fusion of indium. Specifically, about 2 mg of the sample is accurately weighted and placed into an aluminum pan, and an empty aluminum pan is used as a reference. The measurement is performed at a temperature for measurement between 30 and 200° C. at a heating rate of 10° C./min. In the measurement, the temperature is raised to 200° C. once, reduced to 30° C., and again raised. The maximum temperature of the endothermic peak in the DSC curve in the range of temperature of 30 to 200° C. in the second temperature raising process is defined as a melting point.

<Measurement of Weight Average Particle Diameter (D4) of Toner>

The weight average particle diameter (D4) of the toner is determined as follows: Particle diameters are measured with 25000 channels (the effective measurement channel number) using a precise particle diameter distribution measurement apparatus “Coulter counter Multisizer 3” (registered trademark, manufactured by Beckman Coulter, Inc.) including a 100 μm aperture tube and using a micropore electric resistance method and the attached dedicated software “Beckman Coulter Multisizer 3 Version 3.51” (manufactured by Beckman Coulter, Inc.) for setting the conditions for measurement and analyzing the data obtained from the measurement. The data obtained from the measurement is analyzed, followed by calculation of the weight average particle diameter (D4) of the toner. The electrolytic aqueous solution used in the measurement can be Super grade sodium chloride dissolved in deionized water and controlled such that the concentration is about 1% by mass, such as “ISOTON II” (manufactured by Beckman Coulter, Inc.).

Before the measurement and the analysis are performed, the dedicated software is set as follows.

On a “screen to change standard measurement method (SOM)” of the dedicated software, the total count number in the control mode is set to 50000 particles, the number of measurements is set to one time, and the Kd value is set to a value obtained using “standard particle 10.0 μm” (manufactured by Beckman Coulter, Inc.). The threshold and the noise level are automatically set by pressing the button of measurement of threshold/noise level. The current is set to 1600 μA, the gain is set to 2, and the electrolyte solution is set to ISOTON II. The “flush the aperture tube after measurement” is checked. On the “screen to set conversion from pulse to particle diameter” of the dedicated software, the bin interval is set to the logarithm particle diameter, the particle diameter bin is set to 256 particle diameter bins, and the particle diameter range is set to the range from 2 μm to 60 μm.

The specific measurement method includes the following steps (1) to (7).

(1) About 200 ml of the electrolytic aqueous solution is placed into a 250-ml round-bottomed glass beaker dedicated to Multisizer 3. The beaker is set on a sample stand, followed by stirring counterclockwise with a stirrer rod at a rate of 24 rotations/sec. The fouling and air bubbles in the aperture tube are removed by the “flush aperture” function of the analysis software.

(2) About 30 ml of the electrolytic aqueous solution is placed into a 100-ml flat-bottomed glass beaker. About 0.3 ml of a diluted solution is added thereto as a dispersant prepared by diluting “CONTAMINON N” (a 10% by mass aqueous solution of a neutral detergent (pH: 7) for washing a precision measurement apparatus composed of a nonionic surfactant, an anionic surfactant, and an organic builder, manufactured by Wako Pure Chemical Industries, Ltd.) 3 times by mass with deionized water.

(3) A predetermined amount of deionized water is placed into a water bath of an ultrasonic disperser “Ultrasonic Dispersion System Tetora 150” (manufactured by Nikkaki-Bios Co., Ltd.) having an electric output of 120 W in which two oscillators with an oscillation frequency of 50 kHz are built-in in the state where a phase of one oscillator is shifted by 180° to that of the other. To the water bath, about 2 ml of the CONTAMINON N is added.

(4) The beaker in (2) is set in a fixing hole for the beaker in the ultrasonic disperser, and the ultrasonic disperser is operated. The height position of the beaker is adjusted such that the resonance state of the liquid surface of the electrolytic aqueous solution in the beaker is the maximum.

(5) In the state where an ultrasonic wave is applied to the electrolytic aqueous solution in the beaker in (4), about 10 mg of the toner is added to the electrolytic aqueous solution little by little, and is dispersed. Further, the ultrasonic dispersion is continued for 60 seconds. In the ultrasonic dispersion, the temperature of water in the water bath is appropriately adjusted so as to be 10 to 40° C.

(6) Using a pipette, the electrolyte aqueous solution in (5) having a toner dispersed therein is added dropwise into the round-bottom beaker in (1) disposed in the sample stand. The measurement concentration is adjusted so as to be about 5%. Then, the measurement is performed until the number of particles to be measured reaches 50,000.

(7) The measured data is analyzed by the dedicated software attached to the apparatus, and the weight average particle diameter (D4) is calculated. The weight average particle diameter (D4) is the “average diameter” on the analysis/volume statistical value (arithmetic average) screen when graph/% by volume is set by the dedicated software.

<Method of Measuring Average Circularity of Toner>

The average circularity of the toner is measured with a flow type particle image analyzer “FPIA-3000” (manufactured by Sysmex Corporation) on the conditions on measurement and analysis during calibration work.

The principle of measurement by the flow type particle image analyzer “FPIA-3000” (manufactured by Sysmex Corporation) is that particles which are flowing are captured as still pictures, which are subjected to image analysis. A sample added to a sample chamber is fed into a flat sheath flow cell by a sample suction syringe. The sample fed into the flat sheath flow is sandwiched by a sheath solution to form a flat flow. The sample passing through the inside of the flat sheath flow cell is irradiated with stroboscopic light at an interval of 1/60 seconds. Thus, flowing particles can be captured as still pictures. This is a flat flow, which can be captured in focus. The images of particles are captured with a CCD camera. Each captured image is subjected to image processing at an image processing resolution of 512×512 pixels (0.37×0.37 μm per pixel), followed by outline extraction of each particle image and measurement of the projected area S and the perimeter L of the particle image.

Next, the equivalent circle diameter and the circularity are determined using the area S and the perimeter L. The equivalent circle diameter indicates the diameter of a circle having the same area as the projected area of the particle image. The circularity C is defined as a value obtained by dividing the perimeter of the circle from the equivalent circle diameter by the perimeter of the projected image of the particle. The circularity C is calculated from the following equation.

circularity C=2×(π×S)^{1/2}/L

The circularity of the particle image having a circular shape is 1.000. The value of the circularity is smaller as the particle image has larger depressions and projections in the outer periphery. The circularities of particles are calculated, and the range of the circularity from 0.200 to 1.000 is divided into 800. The arithmetic average of the obtained circularities is calculated, and is defined as an average circularity.

A specific measuring method is described as follows. Initially, about 20 ml of ion exchange water from which impurity solid products are preliminarily removed is placed in a glass container. About 0.2 ml of a diluted solution of a dispersant “CONTAMINON N” (10% by mass aqueous solution of a neutral detergent (pH: 7) for washing a precision measurement apparatus composed of a nonionic surfactant, an anionic surfactant, and an organic builder, manufactured by Wako Pure Chemical Industries, Ltd.) is added to the ion exchange water. The diluted solution is prepared by diluting “CONTAMINON N” with ion exchange water about 3 times by mass. About 0.02 g of the sample for measurement is further added, and is dispersed using an ultrasonic disperser for 2 minutes to prepare a dispersion for measurement. At this time, the dispersion is appropriately cooled to a temperature of 10° C. or more and 40° C. or less. The ultrasonic disperser used is a desktop ultrasonic washing and dispersing machine (such as “VS-150” (manufactured by VELVO-CLEAR K.K.)) having an oscillating frequency of 50 kHz and an electrical output of 150 W. A predetermined amount of ion exchange water is placed into the water bath, and about 2 ml of the CONTAMINON N is added into the water bath.

In the measurement, the flow type particle image analyzer provided with a standard object lens (magnification: 10×) is used. A particle sheath “PSE-900A” (manufactured by Sysmex Corporation) was used as a sheath solution. The dispersion prepared according to the procedure is introduced into the flow type particle image analyzer, and 3000 toner particles are measured in an HPF measuring mode and a total count mode. The binarized threshold during particle analysis is 85%, and the analysis particle diameter is designated. Thus, the number proportion (%) and the average circularity of the particles in the range can be calculated. Where the average circularity of the toner is an equivalent circle diameter of 1.98 μm or more and 39.96 μm or less, the average circularity of the toner was determined.

In the measurement, the focus is automatically adjusted with a standard latex particle (such as “RESEARCH AND TEST PARTICLES Latex Microsphere Suspensions 5200A” manufactured by Duke Scientific Co. diluted with ion exchange water) before the measurement is started. Subsequently, the focus is preferably adjusted every 2 hours from the start of the measurement.

In Examples of the present application, measurement was performed on the conditions on measurement and analysis set when the calibration certificate was received, except that the analysis particle diameter was limited to an equivalent circle diameter of 1.98 μm or more and less than 39.69 μm.

### EXAMPLES

The basic configuration and features of the present invention have been described as above. The present invention will now be specifically described based on Examples. However, these Examples should not be construed as limitations to the present invention.

### Production Example of Inorganic Fine Particle 1

The burning furnace used was a hydrocarbon-oxygen mixing burner having a double-tubed structure which enabled formation of an inner flame and an outer flame. A two-fluid nozzle for ejecting a slurry was disposed in a central portion of the burner, and a silicon compound (hexamethylcyclotrisiloxane) as a raw material was introduced. A hydrocarbon-oxygen combustible gas was ejected from around the two-fluid nozzle to form an inner flame and an outer flame as a reducing atmosphere. The atmosphere, the temperature, and the length of the flame were adjusted by controlling the amounts of the combustible gas and oxygen and the flow rates thereof. The silicon compound was formed into a silica fine particle in the flame, and this silica fine particle was further fused into a desired particle diameter. After cooling, the resulting fine particle was collected with a bag filter or the like to yield Inorganic fine particles 1, which were silica fine particles having a number average diameter of 120 nm.

### Production Example of Inorganic Fine Particle 2

While a sodium stearate aqueous solution was being stirred with a homomixer, a zinc sulfate aqueous solution was added to prepare a fine zinc stearate slurry. This slurry was filtered. The resulting metal soap cake was washed with water two times, and then washed with methanol. The resulting metal soap cake after washing was dried in vacuum, and was repeatedly subjected to disintegration treatment with a jet mill to yield Inorganic fine particles 2, which were zinc stearate fine particles having a number average diameter of 250 nm.

### Production Example of Inorganic Fine Particle 3

An ilmenite ore containing 50% by mass of a TiO₂ equivalent was dried at 150° C. for 3 hours, and sulfuric acid was added to dissolve ilmenite to an aqueous solution of TiOSO₄.

After the resulting aqueous solution was concentrated, 10 parts by mass of a titania sol having anatase crystals was added as seeds, followed by hydrolysis at 170° C. A slurry of TiO(OH)₂ containing impurities was prepared.

The slurry was repeatedly washed at a pH of 5 to 6 to sufficiently remove sulfuric acid, FeSO₄, and impurities. A slurry of high-purity metatitanic acid [TiO(OH)₂] was thereby prepared.

After the slurry was filtered, 0.5 parts by mass of potassium dihydrogen phosphate (KH₂PO₄) was added, followed by firing at 240° C. for 4 hours. Then, the product was repeatedly subjected to a disintegration treatment with a jet mill to yield a titanium oxide fine particle having anatase crystals.

The resulting titanium oxide fine particle was dispersed in ethanol. While the titanium oxide fine particle was being stirred, 5 parts by mass of isobutyltrimethoxysilane as a surface treatment agent was added dropwise to 100 parts by mass of the titanium oxide fine particle to perform a reaction.

After dried, the reactant was subjected to a heat treatment at 170° C. for 3 hours, and was repeatedly subjected to a disintegration treatment with a jet mill until titania aggregates disappeared. Thereby, Inorganic fine particles 3 were yielded, which were titanium oxide fine particles having a number average diameter of 40 nm.

### Production Example 1 of White Pigment

An ilmenite ore containing 50% by mass of a TiO₂ equivalent was dried at 150° C. for 3 hours, and sulfuric acid was added to dissolve ilmenite to prepare an aqueous solution of TiOSO₄.

After the resulting aqueous solution was concentrated, 8 parts by mass of a titania sol having rutile crystals was added as seeds, followed by hydrolysis at 150° C. A slurry of TiO(OH)₂ containing impurities was prepared.

The slurry was repeatedly washed at a pH of 5 to 6 to sufficiently remove sulfuric acid, FeSO₄, and impurities. A slurry of high-purity metatitanic acid [TiO(OH)₂] was thereby prepared.

After the slurry was filtered, 0.5 parts by mass of lithium carbonate (Li₂CO₃) was added, followed by firing at 300° C. for 4 hours. Then, the product was repeatedly subjected to a disintegration treatment with a jet mill to yield White pigment 1, which was titanium oxide fine particles having rutile crystals and a number average diameter of 55 nm.

### Production Example 2 of White Pigment

An alcohol aqueous solution of 15.0 parts by mass of water and 165.7 parts by mass of isopropyl alcohol was added to a mixed solution of 100.0 parts by mass of aluminum isopropoxide and 11.1 parts by mass of isopropyl alcohol to perform hydrolysis (molar ratio of water/aluminum alkoxide=1.7, water content in the alcohol aqueous solution: 8.3% by mass).

In the next step, 99.3 parts by mass of isopropyl alcohol was separated through distillation to be recovered, and then an alcohol aqueous solution of 24.9 parts by mass of water and 64.2 parts by mass of isopropyl alcohol was further added to perform hydrolysis (molar ratio of water/aluminum alkoxide=2.8). The water content in the slurry was 7.8% by mass after the hydrolysis step was completed.

Water and isopropyl alcohol in the resulting suspension containing aluminum hydroxide, water, and isopropyl alcohol were removed to yield White pigment 2, which was aluminum hydroxide fine particles having a number average particle diameter of 60 nm.

### Production Example 3 of White Pigment

200 ml of an ethanol/water mixed solution (ethanol content: 50%) was cooled to −20 to 10° C., and 160 g of Ca(OH)₂ was added thereto. While the resulting slurry-like liquid was being strongly stirred, a mixed gas of carbon dioxide gas/nitrogen (content of carbon dioxide gas: 30%) was introduced from a lower portion of a container at a flow rate of 500 to 5000 ml/min to perform a reaction until the pH started to reduce. At this time, the reaction temperature and the introduction rate of the carbon dioxide gas were adjusted to prepare a slurry containing synthetic calcium carbonate having an average primary particle diameter of 130 nm. Furthermore, each dispersion solution was filtered while a low temperate state was kept, followed by sufficient washing with pure water and then drying to yield synthetic calcium carbonate.

Water adjusted to 70° C. was added to the resulting synthetic calcium carbonate such that the solid content was 10% by mass, and the resulting synthetic calcium carbonate was formed into a slurry using a stirring dispersing machine. While 1 kg of the slurry of synthetic calcium carbonate was being stirred using the dispersing machine, 0.2 to 4 g of saponified stearic acid was added, followed by stirring for 1 to 30 minutes, and then press dehydration. The resulting dehydrated cake was dried, and was then made into a powder. Subsequently, fine particles components were removed with an air force classifier to yield White pigment 3, which was calcium carbonate particles having a number average diameter of 90 nm.

### Production Example 4 of White Pigment

Aluminum hydroxide having a purity of 99.0% was used as a starting raw material. A production method by the Bayer process was used, and the firing temperature condition and the atmosphere were appropriately adjusted to synthesize alumina fine particles having a number average particle diameter of 110 (nm).

White pigment 4 was yielded, which was alumina fine particles having a number average particle diameter of 80 (nm).

### Production Example 5 of White Pigment

600 g of microfine zinc oxide (manufactured by Sakai Chemical Industry Co., Ltd., median particle diameter (D50): 0.2 μm) was repulped in water, and 3.50% by mass of a dispersant (manufactured by Kao Corporation, Poise 532A) was mixed relative to the mass of the microfine zinc oxide. 0.61% by mass of acetic acid was mixed to prepare a slurry such that the concentration was 600 g/l. Next, the slurry was spray dried with a lab spray dryer type DCR (manufactured by Sakamoto Giken K.K.) to yield granulated particles. This product was placed into a sagger, and was fired at 1150° C. for 4 hours while being left to stand. The product was cooled, and was then dispersed in 1.0 liter of water. The resulting slurry was filtered, and was dried to yield White pigment 5, which was zinc oxide fine particles having a number average diameter of 30 μm.

### Production Example 6 of White Pigment

At 40° C., 0.80 equivalent of an alkaline substance was mixed with 1 equivalent of a water-soluble magnesium salt preliminarily subjected to refining treatment to perform a reaction. Subsequently, the reaction product with the reaction mother solution was heated under an increased pressure of about 5.9 MPa for about 4 hours to yield magnesium hydroxide. The resulting magnesium hydroxide was fired at 1450° C. for 3 hours using a kanthal furnace. The resulting calcinated product was pulverized (disintegrated), and was classified to yield White pigment 6, which was magnesium oxide particles having a number average diameter of 60 nm.

### Production Example 7 of White Pigment

50 g/liter (concentration in terms of ZrO₂) of a zirconium oxychloride aqueous solution was hydrolyzed to a hydrolysis rate of 90% by boiling under refluxing.

The resulting hydrated zirconia sol had an average primary particle diameter of 100 nm.

1 mol/L of a sodium hydroxide aqueous solution was added to the solution after hydrolysis to adjust the pH to 12. While the aqueous solution after the adjustment of the pH was being stirred, the aqueous solution was kept under refluxing at a boiling temperature for 24 hours. Subsequently, the aqueous solution was filtered, and was washed with 80° C. pure water until the pH of the filtrate reached 8. 200 g/liter (concentration in terms of ZrO₂) of a slurry was prepared.

The slurry was spray dried with a spray dryer, and was then kept at 900° C. for 2 hours to be calcined. White pigment 7 was thus yielded, which was zirconium oxide fine particles having a number average particle diameter of 60 nm.

### Production Example 8 of White Pigment

A silica fine particle was prepared by a burning method where hexamethylcyclotrisiloxane was used as a raw material. The burning furnace used was a hydrocarbon-oxygen mixing burner having a double-tubed structure which enabled formation of an inner flame and an outer flame. A two-fluid nozzle for ejecting a slurry was disposed in a central portion of the burner, and a silicon compound as a raw material was introduced. A hydrocarbon-oxygen combustible gas was ejected from around the two-fluid nozzle to form an inner flame and an outer flame as a reducing atmosphere. The atmosphere, the temperature, and the length of the flame were adjusted by controlling the amounts of the combustible gas and oxygen and the flow rates thereof. The silicon compound was formed into a silica fine particle in the flame, and this silica fine particle was further fused into a desired particle diameter. After cooling, the resulting fine particles were collected with a bag filter to yield White pigment 8, which was silica fine particles having a number average diameter of 100 nm.

### Production Example of Polyester L

polyoxypropylene (2.2)-2,2-bis(4-hydroxyphenyl)propane: 72.0 parts by mass (0.20 mol; 100.0 mol % relative to the total molar amount of polyhydric alcohol)

terephthalic acid: 28.0 parts by mass (0.17 mol; 96.0 mol % relative to the total molar amount of polyvalent carboxylic acid)

tin 2-ethylhexanoate (esterification catalyst): 0.5 parts by mass

The materials above were weighed and placed into a reaction tank provided with a cooling tube, a stirrer, a nitrogen inlet pipe, and a thermocouple. Next, the flask was purged with nitrogen gas, and was gradually heated under stirring. While being stirred at a temperature of 200° C., the materials were reacted for 4 hours.

Furthermore, the inner pressure of the reaction tank was reduced to 8.3 kPa, and was kept for 1 hour. The reaction tank was then cooled to 180° C., and the inner pressure was returned to the atmospheric pressure (first reaction step).

trimellitic anhydride: 1.3 parts by mass (0.01 mol; 4.0 mol % relative to the total molar amount of polyvalent carboxylic acid)

tert-butylcatechol (polymerization inhibitor): 0.1 parts by mass

Subsequently, the materials above were added. The inner pressure of the reaction tank was reduced to 8.3 kPa. While the temperature was kept at 180° C., a reaction was performed for 1 hour. After it was confirmed that the softening point measured according to ASTM D36-86 reached 94° C., the temperature was reduced to terminate the reaction (second reaction step) to yield Polyester L. The resulting Polyester L had a softening point (Tm) of 94° C. and a glass transition temperature (Tg) of 57° C.

### Production Example of Polyester H

polyoxypropylene (2.2)-2,2-bis(4-hydroxyphenyl)propane: 72.3 parts by mass (0.20 mol; 100.0 mol % relative to the total molar amount of polyhydric alcohol)

terephthalic acid: 18.3 parts by mass (0.11 mol; 65.0 mol % relative to the total molar amount of polyvalent carboxylic acid)

fumaric acid: 2.9 parts by mass (0.03 mol; 15.0 mol % relative to the total molar amount of polyvalent carboxylic acid)

tin 2-ethylhexanoate (esterification catalyst): 0.5 parts by mass

The materials above were weighed and placed into a reaction tank provided with a cooling tube, a stirrer, a nitrogen inlet pipe, and a thermocouple. Next, the flask was purged with nitrogen gas, and was then gradually heated under stirring. While being stirred at a temperature of 200° C., the materials were reacted for 2 hours.

Furthermore, the inner pressure of the reaction tank was reduced to 8.3 kPa, and was kept for 1 hour. The reaction tank was cooled to 180° C., and the inner pressure was returned to the atmospheric pressure (first reaction step).

trimellitic anhydride: 6.5 parts by mass (0.03 mol; 20.0 mol % relative to the total molar amount of polyvalent carboxylic acid)

tert-butylcatechol (polymerization inhibitor): 0.1 parts by mass

Subsequently, the materials above were added. The inner pressure of the reaction tank was reduced to 8.3 kPa. While the temperature was kept at 160° C., a reaction was performed for 15 hours. After it was confirmed that the softening point measured according to ASTM D36-86 reached 132° C., the temperature was reduced to terminate the reaction (second reaction step) to yield Polyester H. The resulting Polyester H had a softening point (Tm) of 132° C. and a glass transition temperature (Tg) of 61° C.

### Production Example of Toner 1

| | | |
|---|---|---|
| Polyester L | 75.00 | parts by mass |
| Polyester H | 25.00 | parts by mass |
| Fischer-Tropsch wax | 5.00 | parts by mass |
| (peak temperature of the largest | | |
| endothermic peak: 90°C.) | | |
| White pigment 1 | 40.00 | parts by mass |
| aluminum 3,5-di-t-butylsalicylate | 0.50 | parts by mass |
| compound | | |
| Inorganic fine particle 1 | 1.50 | parts by mass |

Using a Henschel mixer (FM-75 type, manufactured by Mitsui Mining Co., Ltd.), the raw materials listed in the above formula were mixed at a number of rotations of 20 s′ for a rotation time of 5 min. Subsequently, the resulting mixture was kneaded with a double-screw kneader (PCM-30 type, manufactured by Ikegai Corp.) set to a temperature of 125° C. The resulting kneaded product was cooled, and was roughly ground into 1 mm or less with a hammer mill to yield a ground product. The resulting ground product was pulverized with a mechanical mill (T-250, manufactured by FREUND-TURBO CORPORATION). Furthermore, the pulverized product was classified using a rotary classifier (200TSP, manufactured by Hosokawa Micron Corporation) to yield a toner particle. For the operational conditions of the rotary classifier (200TSP, manufactured by Hosokawa Micron Corporation), classification was performed with the number of rotations of a classification rotor set to 50.0 s⁻¹. The resulting toner particles had a weight average particle diameter (D4) of 5.7 μm.

4.5 parts by mass of Inorganic fine particle 1 was added to 100 parts by mass of the resulting toner particle, followed by mixing with a Henschel mixer (FM-75 type, manufactured by Mitsui Mining Co., Ltd.) at a number of rotations of 30 s⁻¹ for a rotation time of 10 min. The resulting mixture was subjected to a heat treatment with the surface treatment apparatus shown in FIG. 1 to yield a heat-treated toner particle. For the operational conditions, the feed amount was 5 kg/hr, the hot air temperature C was 220° C., the hot air flow rate was 6 m³/min., the cooling air temperature E was 5° C., the cooling air flow rate was 4 m³/min., the absolute moisture content in the cooling air was 3 g/m³, the blower air amount was 20 m³/min., and the injection air flow rate was 1 m³/min. The resulting treatment toner particles had an average circularity of 0.963 and a weight average particle diameter (D4) of 6.2 μm.

0.5 parts by mass of titania fine particles containing primary particles having a number average particle diameter of 32.0 nm was added to 100 parts by mass of the resulting treated toner particle, followed by mixing with a Henschel mixer (FM75 type, manufactured by Mitsui Miike Kakoki K.K.) at a circumferential speed of 45 m/sec for 5 min. The product was passed through an ultrasonic vibration sieve having an opening of 54 μm to yield Toner 1.

### Production Examples of Toners 2 to 18 and Comparative Toners 1 to 4

Toners 2 to 18 and Comparative Toners 1 to 4 were prepared in the same manner as in Production Example of Toner 1 except that White pigment 1 was replaced with White pigments 2 to 8 as shown in Table 1 or Inorganic fine particle 1 were replaced with Inorganic fine particle 2 or Inorganic fine particle 3.

### Production Example of Two-Component Developer 1

Toner 1 and magnetic ferrite carrier particles (number average particle diameter: 35 μm) surface coated with a silicone resin were charged into a V-type mixer (V-10 type: manufactured by Tokuju Seisakusho K.K.) such that the toner concentration was 9% by mass. After charged, these were mixed under the conditions at 0.5 s⁻¹ for a rotation time of 5 min to yield Two-component developer 1.

### Production Examples of Two-Component Developers 2 to 18 and Comparative Two-Component Developers 1 to 4

Two-component developers 2 to 18 and Comparative Two-component developers 1 to 4 were prepared in the same manner as in Production Example of Two-component developer 1 except that Toner 1 was replaced with Toners 2 to 18 and Comparative Toners 1 to 4 as shown in Table 1.

### Example 1

Two-component developer 1 was evaluated as follows. The results of evaluation are shown in Table 2.

<Evaluation 1>

Two-component developer 1 was charged into the cyan station in a full-color copier image PRESS C800 manufactured by Canon Inc., and the developing conditions were appropriately adjusted such that the amount of toner to be applied onto a paper sheet to form an FFH image (solid image) was 1.2 mg/cm².

Using a black paper sheet having an image density of 1.5 or more as a paper sheet for evaluation, Evaluations 1-1 to 1-3 were performed while Toner 1 was replenished as needed. The image density was measured using an X-Rite color reflection densitometer (500 series: manufactured by X-Rite, Incorporated).

The FFH image indicates the image corresponding to the 256th gradation (solid portion) where 256 gradations are represented by hexadecimal notation.

[Evaluation 1-1]

A continuous paper feeding test of 500 sheets (A4 horizontal, coverage rate of 80%) was performed under a low temperature and low humidity environment (15° C., 10% RH). During the continuous paper feeding test of 500 sheets, the sheets are fed under the same developing conditions and transfer conditions (without calibration) as those on the first sheet.

The image densities of all the FFH image portions (solid portions) of the images formed on the 500 sheets were measured, and the difference between the highest density and the lowest density was calculated. The criteria for evaluation are shown as follows:

A: less than 0.05 (very excellent)
B: 0.05 or more and less than 0.10 (good)
C: 0.10 or more and less than 0.20 (non-problematic level in the present
invention)
D: 0.20 or more (unacceptable in the present invention)

[Evaluation 1-2]

The image outputting environment was changed over 8 hours from under a low temperature and low humidity environment (15° C., 10% RH) to under a high temperature and high humidity environment (30° C., 80% RH). Immediately thereafter, a continuous paper feeding test of 500 sheets (A4 horizontal, coverage rate of 80%) was performed, and the stability of the image density was evaluated in the same manner as above.

[Evaluation 1-3]

The full-color copier was left to stand for 10 hours or more under a high temperature and high humidity environment (30° C., 80% RH) to be settled sufficiently in the usage environment. A continuous paper feeding test of 500 sheets (A4 horizontal, coverage rate of 80%) was performed in the same manner as above, and the stability of the image density was evaluated in the same manner as above.

<Evaluation 2>

A modified full-color copier imageRUNNER ADVANCE C5255 manufactured by Canon Inc. was used as an image forming apparatus, and Two-component developer 1 was charged into the developing unit of the magenta station to perform evaluation below.

The evaluation was performed under a normal temperature and normal humidity environment (23° C., 50% RH), and the paper sheet for evaluation was a plain copy paper sheet GFC-081 (A4, basis weight: 81.4 g/m², commercially available from Canon Marketing Japan Inc.).

Images were formed while the amount of the toner to be applied onto the paper sheet was varied. The relation between the image density and the amount of the toner to be applied onto the paper sheet was examined. From the obtained relation, the amount of the toner to be applied where the image density was 0.40 was determined. From the amount of the toner to be applied (mg/cm²), the coloring ability of the toner was evaluated according to the following criteria:

A: less than 0.35 (very excellent)
B: 0.35 or more and less than 0.50 (good)
C: 0.50 or more and less than 0.65 (non-problematic level in the present
invention)
D: 0.65 or more (unacceptable in the present invention)

<Evaluation 3>

The paper sheet for evaluation left to stand for 48 hours or more under a high temperature and a high humidity (30° C., 80% RH) environment and sufficiently absorbed moisture was used, and printing was performed under a high temperature and high humidity environment. The image forming apparatus used was the apparatus after Evaluations 1-3 was performed. The image used was a halftone chart of isolated one dot, and the dot reproductivity was evaluated according to the following criteria for determination:

A: Dots are truly reproduced.

B: A slight change in dot size can be visually observed.

C: A small change in dot size can be visually observed.

D: A remarkable change in dot size can be visually observed.

<Evaluation 4>

An image (print area ratio: 4%) of a lattice pattern with a line width of 3 pixels was printed across the entire paper sheet of size A4 using the apparatus after Evaluations 1-3 was performed. Five points in the resulting image were selected at random to measure the line width with a microscope VK-8500 (manufactured by Keyence Corporation). The average d (μm) of the line widths of the three points excluding the minimum value and the maximum value from the obtained values was calculated. The line width of the 3 pixels is theoretically 127 μm. The thin line reproductivity was evaluated based on the difference L (μm) between 127 μm and the average d (μm).

L (μm)=|127−d|

A: L is less than 10 μm.

B: L is 10 μm or more and less than 15 μm.

C: L is 15 μm or more and less than 20 μm.

D: L is 20 μm or more.

### Examples 2 to 18 and Comparative Examples 1 to 4

Evaluations were performed in the same manner as in Example 1 except that Two-component developer 1 was replaced with Two-component developers 2 to 18 and Comparative developers 1 to 4. The results of evaluation are shown in Table 2.

TABLE 1

| | | | | | Inorganic fine particle used | | | | Inorganic fine particle used in | | | |
|---|---|---|---|---|---|---|---|---|---|---|---|---|
| | | | | | in melt kneading | | | | surface treatment | | | |
| | | | | | | | | Amount | | | | Amount |
| | White pigment | | | | | | | added | | | | added |
| | | | | Content | Inorganic | | | *1 | Inorganic | | | *2 |
| | White | | Work | (parts | fine | | Work | (parts | fine | | Work | (parts |
| Example | pigment | | function | by | particle | | function | by | particle | | function | by |
| No. | No. | Composition | (eV) | mass) | No. | Composition | (eV) | mass) | No. | Composition | (eV) | mass) |
| Example 1 | 1 | Titanium | 6.05 | 40.0 | 1 | Silica | 6.18 | 1.50 | 1 | Silica | 6.18 | 4.5 |
| | | oxide | | | | | | | | | | |
| Example 2 | 1 | Titanium | 6.05 | 40.0 | 1 | Silica | 6.18 | 1.50 | 1 | Silica | 6.18 | 3.5 |
| | | oxide | | | | | | | | | | |
| Example 3 | 1 | Titanium | 6.05 | 40.0 | 1 | Silica | 6.18 | 1.50 | 1 | Silica | 6.18 | 5.5 |
| | | oxide | | | | | | | | | | |
| Example 4 | 1 | Titanium | 6.05 | 40.0 | 1 | Silica | 6.18 | 0.75 | 1 | Silica | 6.18 | 3.5 |
| | | oxide | | | | | | | | | | |
| Example 5 | 1 | Titanium | 6.05 | 40.0 | 1 | Silica | 6.18 | 1.75 | 1 | Silica | 6.18 | 3.5 |
| | | oxide | | | | | | | | | | |
| Example 6 | 1 | Titanium | 6.05 | 40.0 | 2 | Zinc stearate | 6.26 | 0.75 | 1 | Silica | 6.18 | 3.5 |
| | | oxide | | | | | | | | | | |
| Example 7 | 2 | Aluminum | 5.92 | 40.0 | 2 | Zinc stearate | 6.26 | 0.75 | 1 | Silica | 6.18 | 3.5 |
| | | hydroxide | | | | | | | | | | |
| Example 8 | 3 | Calcium | 6.03 | 40.0 | 2 | Zinc stearate | 6.26 | 0.75 | 1 | Silica | 6.18 | 6.8 |
| | | carbonate | | | | | | | | | | |
| Example 9 | 4 | Alumina | 5.94 | 40.0 | 2 | Zinc stearate | 6.26 | 0.75 | 1 | Silica | 6.18 | 2.5 |
| Example 10 | 5 | Zinc oxide | 6.04 | 40.0 | 2 | Zinc stearate | 6.26 | 0.75 | 1 | Silica | 6.18 | 2.5 |
| Example 11 | 5 | Zinc oxide | 6.04 | 40.0 | 2 | Zinc stearate | 6.26 | 0.75 | 1 | Silica | 6.18 | 8.5 |
| Example 12 | 5 | Zinc oxide | 6.04 | 40.0 | 2 | Zinc stearate | 6.26 | 0.75 | | | | |
| Example 13 | 5 | Zinc oxide | 6.04 | 40.0 | 2 | Zinc stearate | 6.26 | 2.45 | — | — | — | — |
| Example 14 | 5 | Zinc oxide | 6.04 | 40.0 | 2 | Zinc stearate | 6.26 | 2.60 | — | — | — | — |
| Example 15 | 5 | Zinc oxide | 6.04 | 25.0 | 2 | Zinc stearate | 6.26 | 2.60 | — | — | — | — |
| Example 16 | 5 | Zinc oxide | 6.04 | 50.0 | 2 | Zinc stearate | 6.26 | 2.60 | — | — | — | — |
| Example 17 | 6 | Magnesium | 5.82 | 50.0 | 2 | Zinc stearate | 6.26 | 2.60 | — | — | — | — |
| | | oxide | | | | | | | | | | |
| Example 18 | 7 | Zirconium | 5.8 | 50.0 | 2 | Zinc stearate | 6.26 | 2.60 | — | — | — | — |
| | | oxide | | | | | | | | | | |
| Comparative | 6 | Magnesium | 6.05 | 50.0 | 3 | Titanium | 6.05 | 2.60 | — | — | — | — |
| Example 1 | | oxide | | | | oxide | | | | | | |
| Comparative | 6 | Magnesium | 6.05 | 50.0 | — | — | — | — | — | — | — | — |
| Example 2 | | oxide | | | | | | | | | | |
| Comparative | 8 | Silica | 6.18 | 50.0 | 1 | Silica | 6.18 | 2.70 | — | — | — | — |
| Example 3 | | | | | | | | | | | | |
| Comparative | 6 | Magnesium | 6.05 | 65.0 | 1 | Silica | 6.18 | 2.70 | — | — | — | — |
| Example 4 | | oxide | | | | | | | | | | |

In the table, *1 represents the amount of the inorganic fine particle added relative to 100 parts by mass of the binder resin.
*2 represents the amount of the inorganic fine particle added relative to 100 parts by mass of the toner particle before heat treatment.

TABLE 2

| | | | Evaluation 1-2 | | | | | | | | |
|---|---|---|---|---|---|---|---|---|---|---|---|
| | Evaluation 1-1 | | Density stability | | Evaluation 1-3 | | | | | | |
| | Density stability | | immediately after | | Density stability | | | | | | |
| | under low | | changing low | | under low | | Evaluation 2 | | | | |
| | temperature and low | | temperature and low | | temperature and low | | Evaluation of toner | | | | |
| | humidity | | humidity → high | | humidity | | coloring ability | | | | |
| | environment (15° C., | | temperature and | | environment (30° C., | | | Amount | Evaluation 3 | Evaluation 4 | |
| | 10% RH) | | high humidity | | 80% RH) | | | of toner | Dot | Thin line | |
| Example | | Δ(MAX- | | Δ(MAX- | | Δ(MAX- | | applied | reproductivity | reproductivity | |
| No. | Evaluation | MIN) | Evaluation | MIN) | Evaluation | MIN) | Evaluation | (mg/cm²) | Evaluation | Evaluation | L(μm) |
| Example 1 | A | 0.01 | A | 0.01 | A | 0.01 | A | 0.30 | A | A | 5 |
| Example 2 | A | 0.02 | A | 0.02 | A | 0.03 | A | 0.32 | A | B | 10 |
| Example 3 | A | 0.02 | A | 0.03 | B | 0.05 | A | 0.33 | A | A | 5 |
| Example 4 | A | 0.03 | B | 0.05 | B | 0.03 | A | 0.34 | A | A | 7 |
| Example 5 | B | 0.05 | B | 0.06 | A | 0.02 | A | 0.33 | A | A | 8 |
| Example 6 | B | 0.06 | B | 0.05 | B | 0.06 | A | 0.34 | A | A | 6 |
| Example 7 | B | 0.05 | B | 0.07 | B | 0.07 | B | 0.38 | A | A | 7 |
| Example 8 | B | 0.06 | B | 0.06 | B | 0.06 | B | 0.39 | B | A | 5 |
| Example 9 | B | 0.07 | B | 0.07 | B | 0.07 | B | 0.42 | A | B | 12 |
| Example 10 | B | 0.06 | B | 0.07 | B | 0.08 | A | 0.33 | B | B | 11 |
| Example 11 | B | 0.07 | B | 0.08 | B | 0.07 | A | 0.32 | C | B | 12 |
| Example 12 | B | 0.07 | B | 0.07 | B | 0.09 | B | 0.43 | B | B | 13 |
| Example 13 | B | 0.08 | B | 0.08 | C | 0.12 | B | 0.45 | B | C | 16 |
| Example 14 | B | 0.07 | B | 0.07 | C | 0.13 | B | 0.43 | B | C | 15 |
| Example 15 | B | 0.08 | B | 0.09 | C | 0.14 | C | 0.52 | B | C | 17 |
| Example 16 | B | 0.09 | C | 0.14 | C | 0.13 | B | 0.44 | B | C | 18 |
| Example 17 | B | 0.08 | C | 0.15 | C | 0.16 | B | 0.48 | C | C | 17 |
| Example 18 | C | 0.12 | C | 0.17 | C | 0.16 | B | 0.47 | C | C | 16 |
| Comparative | C | 0.16 | C | 0.17 | C | 0.17 | B | 0.48 | C | D | 22 |
| Example 1 | | | | | | | | | | | |
| Comparative | C | 0.17 | D | 0.25 | D | 0.26 | B | 0.49 | C | C | 17 |
| Example 2 | | | | | | | | | | | |
| Comparative | D | 0.22 | D | 0.27 | C | 0.18 | B | 0.48 | D | C | 16 |
| Example 3 | | | | | | | | | | | |
| Comparative | D | 0.32 | D | 0.23 | D | 0.24 | B | 0.48 | D | D | 26 |
| Example 4 | | | | | | | | | | | |

According to the present invention, a white toner can be provided which has high charge uniformity and enables stable print-out of high-quality images irrespective of its usage environment.

The present invention is not limited to the embodiment above, and a variety of changes and modifications can be made without departing from the gist and the scope of the present invention. Accordingly, the following claims will be attached to disclose the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A white toner comprising a white toner particle containing a binder resin, a white pigment and an inorganic fine particle or zinc stearate fine particle,
wherein the white pigment and the inorganic fine particle or zinc stearate fine particle are contained in the white toner particle,
the white pigment has a work function of 5.80 eV or more and 6.10 eV or less,
the content of the white pigment is 15.0 parts by mass or more and 60.0 parts by mass or less relative to 100 parts by mass of the binder resin, and
the inorganic fine particle has a work function of 6.15 eV or more.

2. The white toner according to claim 1, wherein the white pigment is a white pigment selected from the group consisting of a titanium oxide fine particle, a calcium carbonate fine particle, a zinc oxide fine particle, an aluminum oxide fine particle, an aluminum hydroxide fine particle, and a magnesium oxide fine particle.

3. The white toner according to claim 1, wherein the inorganic fine particle is a silica fine particle.

4. The white toner according to claim 1, wherein the inorganic fine particle is contained in an amount of 0.1 parts by mass or more and 15.0 parts by mass or less relative to 100 parts by mass of the binder resin.
